(19) United States
(12) Patent Application Publication
(10) Pub. No.: US 2014/0043565 A1
(43) Pub. Date: Feb. 13, 2014

(54) SUNLIGHT READABLE LCD DEVICES EMPLOYING DIRECTIONAL LIGHT GUIDING FILM

(71) Applicant: YAO-DONG MA, FRISCO, TX (US)

(72) Inventor: YAO-DONG MA, FRISCO, TX (US)

(73) Assignee: MacroDisplay Inc, Richardson, TX (US)

(21) Appl. No.: 13/572,059

(22) Filed: Aug. 10, 2012

(51) Int. Cl. G02F 1/13357

(52) U.S. Cl. 349/67; 349/62

(57) ABSTRACT

The current invention relates to a sunlight readable full color active matrix liquid crystal display devices. By means of a novel Directional Light Guiding (DLG) film structure, both the internal backlight and the external sunlight can be used synergistically for lighting the display so as to deliver superior readability and color quality. A seamless transition between indoor and outdoor applications makes the vivid true color display an ideal solution to portable electronics.

### FIELD OF THE INVENTION

The current invention relates to a sunlight readable full color active matrix liquid crystal display devices. By means of a novel Directional Light Guiding (DLG) film structure, both the internal backlight and the external sunlight can be used synergistically for lighting the display so as to deliver superior readability and color quality. A seamless transition between indoor and outdoor applications makes the vivid color display an ideal solution to portable electronics.

### BACKGROUND OF THE INVENTION

In today's the information age, portable electronic display devices for people on the go, such as notebook computer, lap top computer, hand-held computer, tablet and smart phone and etc., have become more and more popular around the world. Internet cloud computing, wireless communication, multimedia and nano-semiconductor technologies as well as software applications are boosting those computers as ultra mobile viewing terminals more vigorously in the new century.

Currently, one of the arguments in the electronic display field is that whether we are in the so called post-PC era or the PC+ era. What is the ideal device for the future, PC or tablet? But people tend to ignore the most important factor of the device: visual quality. For example, a touch panel on the top of a display panel as designed in many tablet products today makes such screen's readability unacceptable under the sunlight environment. Users suffer not only from eye strain but also from fatigue as looking at the screen under sunshine. The ideal technological innovation should enable users to carry a single device that is as portable and usable as a tablet but also as powerful and capable as a PC, which has not only a superior readability both in indoor and outdoor applications but also a battery that can last all day.

From display point of view, there are two remaining issues for the current portable devices: poor screen readability and limited color capability when they are viewed under sunshine.

There has been developed a LED backlit transflective LCD for the last few years. The basic structure is that there is a reflective metal layer that covers almost whole pixel area except one hole in each individual pixel structure. It is only the hole area which allows the backlight passing through the color filter and attributes the full color display effect, therefore the LCD works in a color display mode in indoor applications. However, its color saturation is not as good as traditional full color TFT display. In case of outdoor usage, on the other hand, the display works in a black-and-white mode due to the sunlight reflection of the metal layer. Such insufficient color quality in transmission mode and black-and-white sunlight reflection mode has limited its applications. Furthermore, it might not be feasible to produce a small size but high resolution display.

Other LCD companies around the world produce transflective full color displays with a semi-transparent metal layer underneath the color filter structure. Obviously, the use of thin metal layer remarkably reduces the display's brightness and transmission in the indoor backlight mode. And the color quality of the display under the sunshine is not satisfactory either.

In the U.S. Pat. No. 7,427,140, the applicant discloses a sunlight readable direct-view and projection-view computing device, which is herein incorporated by reference. When the computing device works in the direct-view mode, the display panel tilt up to the conventional display position and it has a wide, open viewing angle; when it works in the projection view mode, the display panel tilts down and forms a projection image via a mirror plate with a sufficient high contrast ratio and superior readability even directly under sunshine.

In the U.S. Pat. No. 7,853,288, the applicant discloses a sunlight illuminated and sunlight readable mobile phone, which is herein incorporated by reference. The display panel opens a transparent window to the ambient light, which allows the sunlight to illuminate the display in both indoor and outdoor applications. A light collecting panel is introduced to reflect the external light with a suitable angle relative to the display panel.

### SUMMARY OF THE INVENTION

It is the primary object of this invention to create a user-friendly sunlight readable full color display device.

It is another object of this invention to create a superior readability both in indoor and outdoor applications.

It is still another object of this invention to use a directional light guiding (DLG) means disposed between a backlight panel and an ever-opening window structure.

It is again the object of this invention to design at least one layer of DLG film to recycle the light from an internal backlight unit into the display and to guide the sunlight as an external backlight into the display panel.

It is another object of this invention to harness solar energy for the benefit of illuminating the display and boosting the battery's working life.

It is a further object of this invention to create a mechanical-shutter-free window structure to realize a seamless conversion between the internal lighting mode and the external lighting mode.

It is another object of this invention to maintain the advantageous passive display performances and enrich such display into outdoor applications so as to prolong the life cycle of the LCD.

It is again the object of this invention to create high contrast and clear images for touch panel display devices.

It is another object of this invention to create a substantially transparent window structure for the display devices.

### BRIEF DESCRIPTION OF THE DRAWINGS

FIG. 1 illustrates a schematic sunlight readable liquid crystal display employing a single layer of directional light guiding film.

FIG. 2 illustrates a schematic sunlight readable liquid crystal display employing two layers of directional light guiding films.

FIG. 3 illustrates a schematic sunlight readable liquid crystal display employing two layers of directional light guiding films with different disposition and a diffuser.

FIG. 4 illustrates a schematic sunlight readable liquid crystal display employing three layers of directional light guiding films.

FIG. 5 illustrates a sunlight illuminated and sunlight readable computer structure with a built-in backlight unit and a sunlight window.

FIG. 6 illustrates a sunlight illuminated and sunlight readable tablet structure with a whole built-in backlight unit and a partial sunlight window.

### DETAILED DESCRIPTION

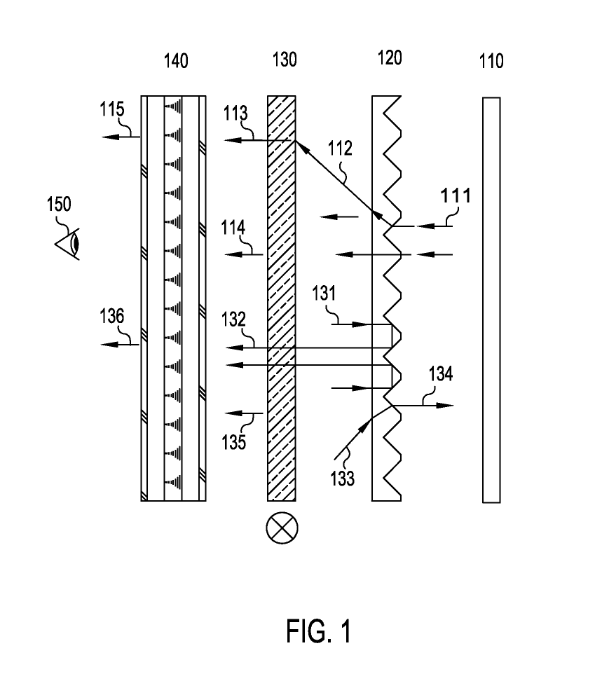

Referring first to FIG. 1, illustrated is schematic sunlight readable liquid crystal display employing a single layer of directional light guiding film. A fixed substantially transparent window structure 110 allows sunlight or ambient light to be a backlit source of the display. The directional light guiding (DLG) film 120 is disposed between the window structure 110 and the conventional built-in backlight structure 130, wherein the structure 130 is a multi-layer congregation consists of LED bar, light guide panel, front diffuser and light enhancement film. A TFT LCD panel 140, including an active matrix LCD cell structure, polarizers and electronic connecter, is located in front of the built-in backlight structure 130. The display's rigid or flexible PC board and related video cable should be clear from the pixel area. Any opaque components should not be wrapped up to block the effective pixels from the illumination of the external lighting. A capacitive or resistive touch panel may also be attached to the front surface of the display panel 140.

The DLG film can be made of a transparent polymer with high reflective index, for example, polyester film. The profile of the two surfaces, as shown in FIG. 1, is different, wherein the first surface has a zigzag micro-lens structure with a pitch of 25-50 micrometers and a height of 12-25 micrometers while the second surface is a flat surface. The total thickness of the DLG film is in a range of 40 to 200 micrometers, more preferably 50 to 125 micrometers. The angle of the zigzag slants should be satisfying with the requirement of internal full light reflection, for example, 45 degrees. Therefore, the micro lens will be of a 90-degree rib structure. A high refractive index di-electric coating layer, for example, nano TiO2, ITO and Tin Oxide can be deposited onto the either side of the DLG film in order to enhance the lighting efficiency.

When a beam of sunlight 111, passing through the window 110, hits on the DLG film 120, one portion of it will be deflected by the DLG into the light 112 with an angle. Then it passes through the built-in backlight structure to form a forwarding light 113. The other portion of it will be able to directly pass through the DLG film to form the light 114. Finally, the light 113 and 114 emerge from the LCD panel as a full color image 115 to a viewer 150.

When an artificial light 131 out of the built-in backlight structure hits on the DLG film 120 vertically from the side opposite to the sunlight, it will be bounced back to form the light 132 due to the full internal reflection. On the other hand, when a beam of artificial light 133 out of the built-in backlit structure hits on the DLG film 120 at a certain angle, the portion that hits on one directional slant surface will be deflected and out of the DLG film to form the light 134. While the other portion that hits on the second directional slant surface will be reflected internally and then emerged from the adjacent slant surface as a substantially horizontal light. Meanwhile, the portion of the forward backlit light 135 will join the light 132 and pass through the display panel to form display light 136. As a result, approximately 60% backward light from the backlighting unit will be recycled and 40% of it will travel through the DLG film.

Please note that both light 115 and 136 will contribute to the readability of the display. In indoor application, the latter plays a dominate role to the viewer, like a conventional display device. In outdoor application, on the other hand, especially directly under the sunshine, the former will be many times brighter than the latter. Therefore, the outdoor color image is still as clear as indoor environment even when a touch panel is attached to the display device. In a cloudy weather condition, such joint illumination makes display images vivid and comfortable to the viewer.

The DLG film 120, as shown in FIG. 1, should not be limited in a zigzag micro lens structure, any type of micro structure on the surface with different profile, such as micro ball, micro droplets, micro pool, micro bar, micro hole or any other type of reflective /diffusive film, wherein the first directional light can be reflected back while the second directional light from the opposite direction can be guided forward, could be also utilized in the present invention. Any of the DLG thin film structure that constitutes the principle of the embodiment is within the scope of the present invention.

The window structure 110, as shown in FIG. 1, is a substantially transparent layer. It might be a completely open area in a back lid structure; or it might be a transparent plastic plate fabricated as a part of the back closure; it also might be a non-transparent material such as a metal layer with a majority open cavity area, such as embossed slot holes punched in a predetermined direction or spherical holes all over the plate. In this case, a reflective coating might be deposited onto the internal surface of the poly-hole window to enhance the light efficiency. Broadly speaking, the opening area should be as large as possible to guide the sunlight into the display panel.

Therefore, the present invention creates a dual backlighting mode, which remarkably increases performances of display devices. One of the advantageous properties of the present invention is that the inside backlight and environmental sunlight is totally compatible. This means that the synergistically lighting can meet various displays' illuminating requirements no matter in the indoor condition, in the dark cloudy condition or in the sunlight exposing condition. The other advantageous property of the present invention is that it will be applicable to most portable and mobile devices wherein the transition from indoor to outdoor is inevitable. Users will feel comfortable for such a seamless transition between inside and outside of the building because the imaging quality will be remaining almost the same. A sensor may be embedded into the device to shut down the internal backlight during the sunny outdoor application just like an auto sensor in a car lighting system wherein the transition is hardly discernable. Thus it will prolong the working hours of the battery and the device itself.

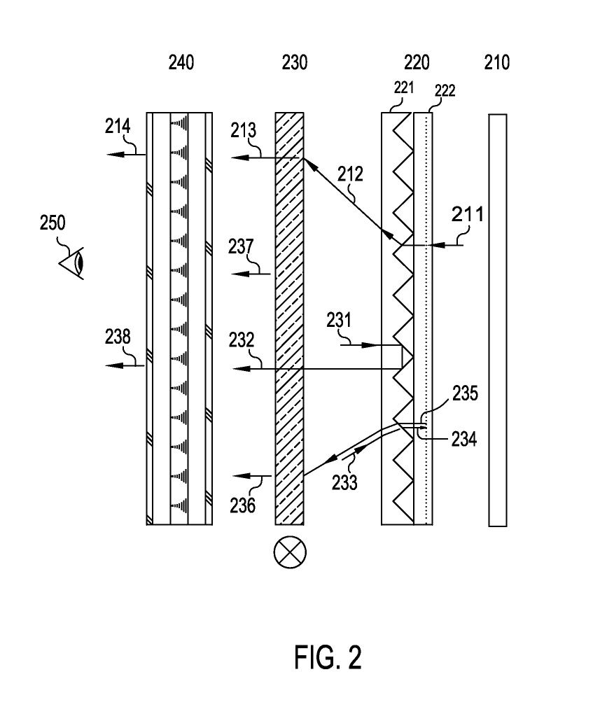

Turning now to FIG. 2, illustrated is a schematic top-view of a sunlight readable liquid crystal display employing two layers of directional light guiding films. A fixed transparent window structure 210 allows sunlight or ambient light to be a backlight source of the display. A stack of DLG films 220 is disposed between the window structure 210 and the conventional built-in backlight assembly 230. DLG film 221 and film 222 are stacked together with their micro-lenses facing to each other and with their ribs cross to each other at 90 degrees. The rib of the 221 is of vertical alignment, while the 222 is arranged horizontally. The assembly 230 consists of LED bar, light guide panel, front diffuser, light enhancement film, and etc. A TFT LCD panel 240, including an active matrix LCD cell structure and polarizers, is located in front of the built-in backlighting assembly 230. A capacitive or resistive touch panel may also be attached to the front surface of the display panel 240.

When a downward sunlight beam 211, passing through the window 210, hits on the DLG film 222 and 221, it will be deflected to form the light 212 with an angle. And then it passes through the built-in backlight structure and becomes a forwarding light 213. Finally, the light 213 travels through LCD panel as a full color imaging light 214 to a viewer 250.

When an artificial light 231 out of the built-in backlight structure hits on the DLG film 221 vertically from the side opposite to the sunlight, it will be bounced back to form the light 232 due to full internal reflection. When an artificial light 233 out of the built-in backlight structure hits on the DLG film 221 at a certain angle, it will be deflected and out of the first DLG film to form the light 234. Such light 234 will be bounced back from the second DLG film to form the light 235, which further becomes light 236 after passing through the backlight structure. A major portion of the forward backlit light 237 will join the light 232 and the light 236 to pass through the display panel 240 and form display light 238.

Please note that both the light 214 and 238 contribute to the readability of the display. In indoor applications, as in the conventional display devices, the latter plays a dominate role to the viewer. In outdoor applications, on the other hand, especially under sunshine, the former will be many times brighter than the latter. In this case, the display's color image is almost as clear as indoor environment. In a cloudy weather condition, such joint illumination makes outdoor-view very comfortable to the viewer.

By stacking the second DLG film, the leaking portion 134 depicted in FIG. 1 now can be recycled as the light 235. Generally, two-layer stacking composition allows approximately 80% backward light out of the backlight unit to be reflected to the display panel.

The most advantageous feature of the above-mentioned embodiment is that the downward sunlight is guided perfectly by the second DLG film and then turned out to be a substantially parallel horizontal beam which passes through the first DLG film as the angular light for illuminating the display panel. It is such a novel optical design that contributes to the superior color images in the outdoor sunshine environment.

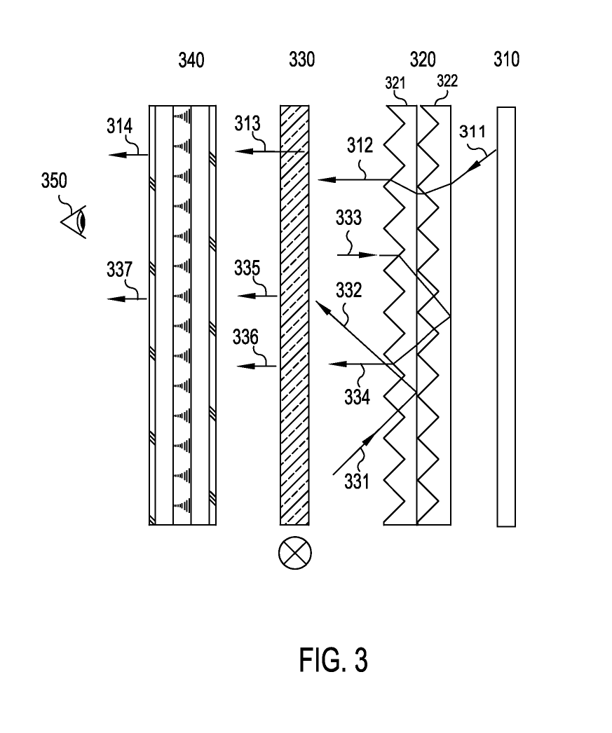

Turning now to FIG. 3, illustrated is a schematic sunlight readable liquid crystal display employing two layers of DLG films. A fixed diffusive window structure 310 allows sunlight or ambient light to be a backlight source of the display. A stack of DLG films 320 is disposed between the window structure 310 and the conventional built-in backlight assembly 330. DLG film 321 and film 322 are stacked together with their micro-lenses facing to the same direction and with their ribs parallel to each other. They are aligned horizontally. The assembly 330 consists of LED bar, light guide panel, front diffuser and light enhancement film and etc. A TFT LCD panel 340, including an active matrix LCD cell structure and polarizers, is located in front of the built-in backlight assembly 330. A capacitive or resistive touch panel may also be attached to the front surface of the display panel 340.

A beam of sunlight passing through the diffusive window 310 becomes diffusive light 311. It then hits on the DLG film 322 and 321 and becomes the deflected light 312. And it further passes through the built-in backlight structure to form a forwarding light 313. Finally, the light 313 travels through LCD panel as a full color imaging light 314 to a viewer 350.

When an artificial light 331 out of the built-in backlight structure hits on the DLG film 321 at a large angle, it will be bounced back to form the light 332 due to the full internal reflection from the internal flat surface. Meanwhile, as an artificial light 333 out of the built-in backlight structure hits on the DLG film 321 vertically, it will be out of the first DLG film and precede to be bounced back from the flat surface of the second DLG film to form the light 334, which further joins with the light 332 and becomes the light 335 after passing through the backlight structure. The portion of the forward backlight light 336 will join the light 335 to pass through the display panel 340 to form display light 337.

Please note that both the light 314 and 337 will contribute to the readability of the display. In indoor applications, as in the conventional display device the latter plays a dominate role to the viewer. In outdoor applications, on the other hand, especially directly under sunshine, the former will be many times brighter than that of the latter. In this case, the display's color image is still as clear as indoor environment. In a cloudy weather condition, such joint illumination makes outdoor-view comfortable to the viewer.

By stacking the second DLG film, the leaking portion 333, now can be recycled as the light 334. Approximately, two-layer stacking structure allows 80% backward light from the backlight structure to be reflected to the display panel.

Optically, the diffusive window structure makes the display less sensitive to the external lighting direction. It may also eliminate the possible rainbow birefringence effect of the stacking DLG films. Mechanically, the diffusive window structure can work as a part of the back closure of the display device.

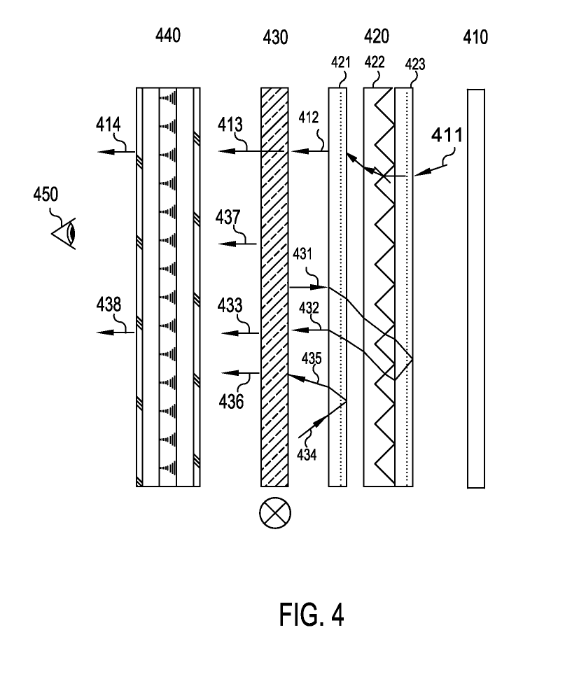

Turning now to FIG. 4, illustrated is a schematic top-view of a sunlight readable liquid crystal display employing three layers of directional light guiding films. A fixed transparent window structure 410 allows sunlight or ambient light to be a backlight source of the display. A stack of DLG films 420 is disposed between the window structure 410 and the conventional built-in backlight assembly 430. DLG film 421, 422 and 423 are stacked together with a predetermined alignment. The rib of the 421 is of horizontal alignment and facing to the backlight panel 430; the rib of 422 is of vertical alignment and the 423 is arranged horizontally. Micro-lenses of 422 and 423 are facing to each other. The assembly 430 consists of LED bar, light guide panel, front diffuser, light enhancement film and etc. A TFT LCD panel 440, including an active matrix LCD cell structure and polarizers, is located in front of the built-in backlight assembly 430. A capacitive or resistive touch panel may also be attached to the front surface of the display panel 440.

When a beam of sunlight 411, passing through the window 410, hits on the DLG film 423, 422 and 421, it will be deflected into the light 412. And then it passes through the built-in backlight structure to form a forwarding light 413. Finally, the light 413 travels through LCD panel as a full color imaging light 414 to a viewer 450.

When an artificial light 431 out of the built-in backlight structure hits on the DLG film 421 vertically, it will be bounced back to form the light 432 due to the full internal reflection and then it passes through backlight structure 430 and becomes the light 433. Meanwhile, when an artificial light 434 out of the built-in backlight structure hits on the DLG film 421 at a certain angle, it will be deflected and out of the first DLG film to form the light 435, which further becomes light 436 after passing through the backlight structure. The portion of the forward backlit light 437 will join the light 433 and the light 436 to pass through the display panel 440 to form display light 438.

Please note that both the light 414 and 438 will contribute to the readability of the display. In indoor applications, as in the conventional display device, the latter plays a dominate role to the viewer. In outdoor applications, on the other hand, especially under the sunshine, the former will be many times brighter than the latter. In this case, the display's color image is approximately as clear as indoor environment. In a partially cloudy weather condition, such joint illumination makes outdoor-view gentle and comfortable to the viewer.

By stacking multiple layers of DLG films, the leaking portion 134, depicted in FIG. 1, now can be recycled as the light 432. Generally, three layer stacking structure allows approximately 88% backward light out of the backlight structure to be reflected to the display panel. The total thickness of the three-layer DLG composition can be a thin film structure, for example, 195 micrometer, which is comparable to the conventional one layer white film (180 micrometer).

The most advantageous feature of the embodiment is that the downward sunlight can be guided perfectly through the third DLG film and then turned out to be substantially parallel horizontal beam which passes through the second DLG film as the angular light and then through the first DLG film as a horizontal light for the illumination of the display panel. It is such a novel optical design that contributes to the water clear color display images in the outdoor sunshine environment.

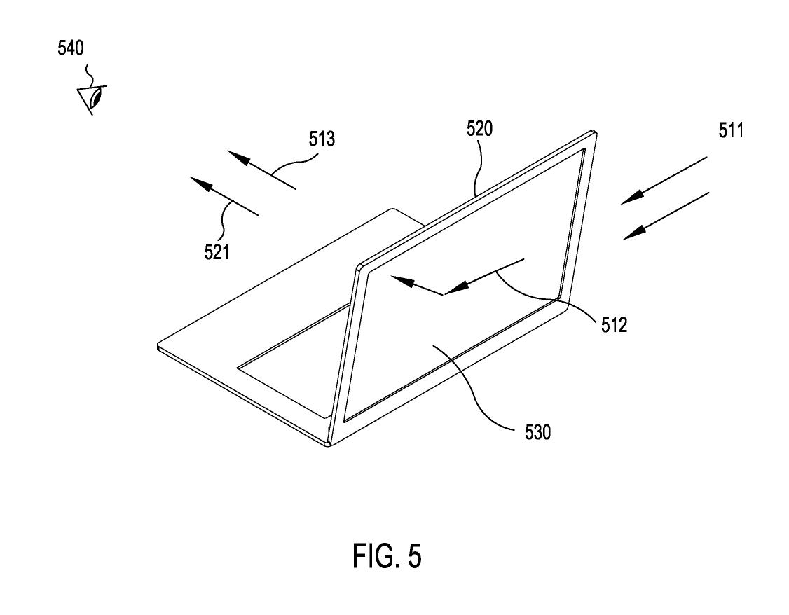

Turning now to FIG. 5, illustrated is a schematic structure of a sunlight readable PC computer. The computer is substantially similar to a conventional PC except a transparent window 530 opening on the back lid. An internal backlight unit and a TFT display panel within the housing 520 are of approximately the same area as the window 530. A DLG film structure is disposed inside the window structure as shown in the FIG. 1-4. The substantially transparent window can be embedded on the back lid or be molded by the same plastic material as the part of back closure decorated by a printing or coating process.

A beam of sunlight 511 passing through the window 530 becomes deflected light 512. It proceeds to pass through the DLG film, the built-in backlight structure and the LCD panel as a full color image 513 to a viewer 540.

The built-in backlight structure will generate an artificial color imaging light 521 to the viewer 540 as described in the above-mentioned embodiment.

There has been an OLED transparent computer structure developed in the recent years demonstrated by some computer producers. However, the working principle is fundamentally different from the present invention. First of all, OLED display is an active lighting component and the light intensity is incomparable with that of the sunlight. It is almost impossible for the OLED display to apply in an outdoor sunlight environment. Secondly, the electric current effect of the OLED will consume a big portion of energy in order to generate a bright image in a normal outdoor lighting condition. On the contrary, the present invention enables the passive TFT display to maintain its superior performances and expand itself into outdoor applications so as to prolong its life cycle remarkably.

Experiment 1

A prototype UMPC computer with a 7″ 480×800 TFT display was fabricated according to the configuration as shown in FIG.3. A series tests were carried out. The control sample was ASUS 7″ Eee PC 701 series. During the test a Konica Minolta CS-100A photometer was used, wherein “Y” represents brightness in the unit of Foot-Lambert (FL) and “x”, “y” represents color coordination of CIE 1931 Chromaticity Diagram.

TABLE 1 is the indoor testing result:

TABLE 1

| Y | x | y | DIG film | lighting | Ratio |
|---|---|---|---|---|---|
| 23.4 | .320 | .338 | none | LED | 100% |
| 14.0 | .318 | .337 | 1 layer | room | 60% |
| 18.5 | .319 | .337 | 2 layer | room | 79% |
| 20.5 | .320 | .335 | 3 layer | room | 87.6% |
| 28.0 | .377 | .398 | 3 layer | window | 119.7% |

As shown in TABLE 1, the brightness of the conventional computer with LED backlight worked as a benchmark (100%) to test the prototype of the present invention.

In a room light condition, brightness increased as the addition of more layers of DLG films. As a result, three-layer stacking structure turned out 87.6% brightness.

In the indoor sunlight condition by a tinted glass window, compared with the prior art computer with LED backlight, the new computer with three layers of DLG structure introduced enough sun light to the display panel, resulting in a higher brightness (119.7%).

TABLE 2 demonstrates the sunlight readable outdoor test:

TABLE 2

| Y | x | y | DIG film | Contrast | Time |
|---|---|---|---|---|---|
| 322 | .349 | .373 | open window | 7.0:1 | 10:00 am |
| 419 | .351 | .373 | 1 layer | 9.1:1 | 10:00 am |
| 357 | .345 | .372 | 2 layer | 7.8:1 | 10:00 am |
| 331 | .361 | .380 | 3 layer | 7.2:1 | 10:00 am |
| 46.0 | .330 | .338 | dark area | | |
| 486 | .351 | .378 | 1 layer | | 1:00 pm |
| 357 | .345 | .376 | 2 layer | | 1:00 pm |
| 305 | .343 | .373 | 3 layer | | 1:00 pm |
| 319 | .346 | .375 | 3 layer | | 4:30 pm |

TABLE 3 is the outdoor test of the control sample EeePC 701SD:

TABLE 3

| Y | x | y | | Contrast | Time |
|---|---|---|---|---|---|
| 109 | .291 | .318 | white area | | 12:30 pm |
| 62.4 | .284 | .297 | black area | 1.7:1 | 12:30 pm |

Conclusions:
1. The brightness and color quality test demonstrated that the present invention delivers a clear color image under the sunshine while the control sample was substantially washed out at the same condition.
2. The indoor test has shown that the present invention can obtain approximately the same or even brighter image than that of the conventional display device.
3. Since there is no physical window or mechanical shutter involved, the novel computer is designed user-friendly. Cosmetically it looks the same as the traditional one.

Experiment 2

In order to further enhance the brightness of the computer prototype, a broadband cholesteric reflective polarizer film was directly laminated onto the back polarizer of the 7″ TFT LCD panel in a clean room environment. Three layers of DLG films were then stacked together behind the backlight panel with the first layer closed to the backlight panel. The configuration corresponding to FIG. 4 is described as shown in TABLE 4.

TABLE 4

| DLG layer | Rib direction | Alignment |
|---|---|---|
| First | inside | horizontal |
| Second | outside | vertical |
| Third | inside | horizontal |

The brightness test of the computer was carried out in indoor and outdoor environment respectively as shown in TABLE 5.

TABLE 5

| Y | x | y | lighting | Cr | time |
|---|---|---|---|---|---|
| 26.4 | .313 | .330 | Room | | 11:00 am |
| 30.2 | .318 | .336 | window skylight | | 11:00 am |
| 40.7 | .327 | .348 | window sunlight | | 11:00 am |
| 270 | .337 | .348 | out sunlight white | | 11:00 am |
| 37.1 | .332 | .345 | out sunlight black | 7.3:1 | 11:00 am |

Conclusions:
1. The modified display panel of the present invention was brighter than that of the conventional display panel in the indoor environment.
2. The indoor window lighting contributed a substantial brightness enhancement that allows the internal backlight panel dimming down or even completely shutting off in indoor environment, which results in much less power consumption and more energy conservation accordingly.
3. When the computer was moving from indoor to outdoor, the color quality and contrast were substantially remaining the same. The readability was remarkably improved. During the transition a sufficient brightness of the internal backlight unit is necessary to achieve a seamless viewing result.

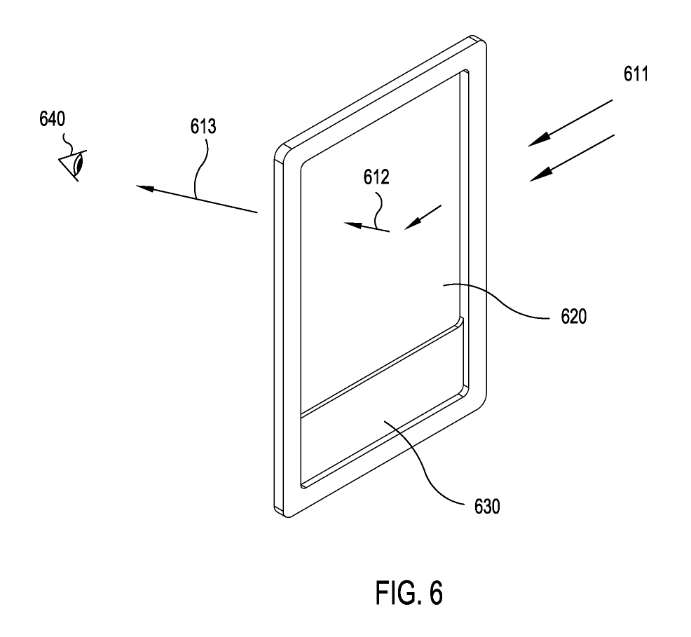

Turning now to FIG. 6, illustrated is a schematic structure of a sunlight readable tablet computer. A sunlit window 620 is opening on the backside of the device. The area of window 620 is smaller than that of the LCD panel or the internal backlight panel 630 due to the fact that the non-transparent motherboard and the battery occupy certain layout space inside the computer housing. However, the window 620 and the LCD window 630 might be the same, if the main circuit board and the bar-type battery could be designed in the surrounding area of the tablet computer. The DLG film may cover a partial area or the whole area of the backlight unit 630 depending on the optic and mechanic design. A capacitive or resistive touch panel must be positioned at the front of the device as an input unit as in the conventional tablet computer.

The working principle has already been described in detail as shown in FIG. 5. The sunlight 611 passing through the window 620 becomes deflected light 612. It proceeds to pass through the DLG film, the built-in backlight structure and the LCD panel as a full color imaging light 613 to a viewer 640. In the sunlight outdoor application, a portion of the display screen illuminated by the sunlight takes on a bright image, while the other portion of the screen illuminated by the internal light takes on a dull image. A software or firmware may be programmed to change the format as well as display resolutions to fit in the sunlit display area.

In an indoor environment and ambient light condition, the built-in backlit unit will generate a full size of display imaging to the viewer 640.

An embedded sensor will be located in the vicinity of the window area to control the conversion between indoor and outdoor display modes.

Broadly speaking, the structure and the spirit of the present invention are not only applicable to the computer but also to the other electronic display devices, such as portable DVD player, digital camera, multi-media player, mobile phone, GPS, TV window and so on.

1. A sunlight readable LCD device comprising:
a. a display panel;
b. an internal backlight panel;
c. at least one layer of directional light guiding film with a predetermined alignment;
d. a transparent external lighting window;
wherein the display panel is attached to one side of the backlight panel while the directional light guiding film is disposed between the opposite side of the internal backlight panel and the transparent external lighting window;
wherein the directional light guiding film reflects a beam of internal backlight to the display panel and introduces a beam of external light through the window simultaneously, resulting in a synergistic illumination of the display panel;
whereby the LCD generates full color images with sufficient brightness and contrast under the outdoor sunlight as well as the indoor ambient light.

2. The sunlight readable LCD device as claimed in claim 1 wherein the display panel is a transparent TFT LCD panel.

3. The sunlight readable LCD device as claimed in claim 1 wherein the transparent internal backlight panel is substantially transparent to the sunlight.

4. The sunlight readable LCD device as claimed in claim 1 wherein the directional light guiding film is a thin polymer film with a substantially flat surface on one side and a zigzag micro-lens surface on the opposite side.

5. The directional light guiding film as claimed in claim 4 wherein the polymer film has a thickness in a range of 40˜200 micrometers.

6. The directional light guiding film as claimed in claim 4 wherein the micro-lens has a 45 degrees tilt angle with the pitch in a range of 12˜25 micrometers.

7. The directional light guiding film as claimed in claim 4 wherein the polymer film has a sufficient refractive index in a range of 1.5˜1.8.

8. The sunlight readable LCD device as claimed in claim 1 wherein the directional light guiding film is one layer film with the micro-lens horizontally aligned and facing the transparent window structure.

9. The sunlight readable LCD device as claimed in claim 1 wherein the directional light guiding film is two-layer film composition with their micro-lenses facing and crossing to each other and with the film horizontally aligned facing the transparent window structure.

10. The sunlight readable LCD device as claimed in claim 1 wherein the directional light guiding film is of at least two layers of composition with their micro-lenses facing to the same side and with their ribs in parallel to one another.

11. The sunlight readable LCD device as claimed in claim 1 wherein the directional light guiding film is three-layer film composition.

12. The sunlight readable LCD device as claimed in claim 1 wherein the transparent external lighting window is a rigid part of the back closure.

13. The sunlight readable LCD device as claimed in claim 1 wherein the LCD device generates color images with the contrast ratio Cr>7.0:1 under direct sunlight.

14. A sunlight readable LCD device comprising:
a. a display panel;
b. an internal backlight panel;
c. at least one layer of directional light guiding film with a predetermined alignment;
d. a diffusive external lighting window;
wherein the display panel is attached to one side of the backlight panel while the directional light guiding film is disposed between the opposite side of the internal backlight panel and the diffusive window;
wherein the directional light guiding film reflects internal backlight to the display panel and introduces external light through the diffusive window simultaneously, resulting in a uniform illumination of the display panel;
whereby the LCD generates full color images with sufficient brightness and contrast under the outdoor sunlight as well as the indoor ambient light.

15. The sunlight readable LCD device as claimed in claim 14 wherein the diffusive external lighting window is a part of diffusive surface of the display back closure.

16. The sunlight readable LCD device as claimed in claim 14 further includes a touch panel.

17. The sunlight readable LCD device as claimed in claim 14 further including a light sensor underneath the diffusive window to set the internal backlight panel ON and OFF, depending on the intensity of the external light.

18. The sunlight readable LCD device as claimed in claim 14 is a PC computer.

19. The sunlight readable LCD device as claimed in claim 14 is a tablet computer.

20. The sunlight readable LCD device as claimed in claim 14 is a mobile phone.
